(19) United States
(12) Patent Application Publication
(10) Pub. No.: US 2006/0269714 A1
(43) Pub. Date: Nov. 30, 2006

(54) Self-adhesive note assembly having multiple note surfaces

(76) Inventors: Bruce Elliot Kramer, Potomac, MD (US); Joy Elizabeth Belin, Potomac, MD (US)

Correspondence Address: BRUCE E. KRAMER, 9112 CHERBOURG DR., POTOMAC, MD, 20854, US

(21) Appl. No.: 11/443,056

(22) Filed: May 31, 2006

Related U.S. Application Data
(60) Provisional application No. 60/685,417, filed on May 31, 2005.

(51) Int. Cl. B32B 33/00

(52) U.S. Cl. 428/40.1

(57) ABSTRACT

A self-adhesive note assembly includes a support in the form of a three dimensional object and at least one stack of self-adhesive notes on each of plural surfaces of the three dimensional object. Another self-adhesive note assembly includes a flat support having a top surface and a bottom surface, wherein the top surface has thereon at least one stack of self-adhesive notes and the bottom surface has at least two stacks of self-adhesive notes. Still another self-adhesive note assembly includes a support having on one side a first surface and second surface, wherein the first surface has thereon at least one stack of self-adhesive notes and the second surface has thereon at least one stack of self-adhesive notes, wherein the support can be folded such that the first surface faces the second surface.

### CROSS REFERENCE TO RELATED APPLICATIONS

This application claims benefit from U.S. Provisional Application No. 60/685,417 filed May 31, 2005.

### FIELD OF THE INVENTION

The present invention provides a self-adhesive note assembly having a plurality of surfaces having self-adhesive notes thereon.

### BACKGROUND OF THE INVENTION

Clutter is a persistent problem in everyday life, including at home, at the office, and while traveling. Clutter makes it difficult to feel organized and work efficiently. It causes a person to waste time searching for something on his or her desk or in his or her briefcase, and gets that person more and more frustrated. For example, that person may be looking for a certain type of self-adhesive note, but because there is so much clutter, the desired note cannot be found.

Thus, there is a need in the art to find a way to reduce clutter, and to enable a person to locate a desired self-adhesive note quickly.

### SUMMARY OF THE INVENTION

One object of the present invention is to provide a way to reduce clutter.

Another object is to provide a self-adhesive note assembly which efficiently and easily presents a person with the desired self-adhesive note, whether at home, at the office, or while traveling.

These and other objects of the present invention are provided by a self-adhesive note assembly having a plurality of surfaces which each have thereon at least one stack of self-adhesive notes, as described in greater detail below.

1. A self-adhesive note assembly comprising a support in the form of a three dimensional object and at least one stack of self-adhesive notes on each of plural surfaces of the three dimensional object. For example, the three dimensional object could have six surfaces, and at least one stack of self-adhesive notes could be present on each of five surfaces of the three dimensional object.

2. A self-adhesive note assembly as in item 1 above, comprising a support in the form of a cube and at least one stack of self-adhesive notes on each of plural surfaces of the cube.

3. A self-adhesive note assembly as in item 2 above, wherein at least one stack of self-adhesive notes is present on each surface of the cube.

4. A self-adhesive note assembly as in item 3 above, comprising a support in the form of a cube and only one stack of self-adhesive notes on each surface of the cube.

5. A self-adhesive note assembly as in item 4 above, wherein each stack of self-adhesive notes is a different color from each other stack of self-adhesive notes.

6. A self-adhesive note assembly as in item 5 above, comprising a purple stack of self-adhesive notes on a first surface of the cube, a blue stack of self-adhesive notes on a second surface of the cube, a green stack of self-adhesive notes on a third surface of the cube, a yellow stack of self-adhesive notes on a fourth surface of the cube, an orange stack of self-adhesive notes on a fifth surface of the cube, and a red stack of self-adhesive notes on a sixth surface of the cube.

7. A self-adhesive note assembly as in item 5 above, comprising a lavender stack of self-adhesive notes on a first surface of the cube, a light blue stack of self-adhesive notes on a second surface of the cube, a light green stack of self-adhesive notes on a third surface of the cube, a light yellow stack of self-adhesive notes on a fourth surface of the cube, an light orange stack of self-adhesive notes on a fifth surface of the cube, and a pink stack of self-adhesive notes on a sixth surface of the cube.

8. A self-adhesive note assembly as in item 2 above, comprising at least two stacks of self-adhesive notes on at least one surface of the cube.

9. A self-adhesive note assembly as in item 8 above, wherein one stack of self-adhesive notes on the cube is a different color from another stack of self-adhesive notes on the cube.

10. A self-adhesive note assembly as in item 8 above, wherein one stack of self-adhesive notes on the cube is a different size from another stack of self-adhesive notes on the cube.

11. A self-adhesive note assembly as in item 1 above, comprising a support in the form of an elongated cube and at least one stack of self-adhesive notes on each of plural surfaces of the elongated cube.

12. A self-adhesive note assembly as in item 11 above, wherein at least one stack of self-adhesive notes is present on each surface of the elongated cube.

13. A self-adhesive note assembly as in item 11 above, wherein the elongated cube has four rectangular faces and two square faces.

14. A self-adhesive note assembly as in item 11 above, wherein the elongated cube has six rectangular faces.

15. A self-adhesive note assembly comprising a flat support having a top surface and a bottom surface, wherein the top surface has thereon at least one stack of self-adhesive notes and the bottom surface has thereon at least two stacks of self-adhesive notes.

16. A self-adhesive note assembly as in item 15 above, wherein the top surface has thereon one stack of large self-adhesive notes and the bottom surface has thereon one stack of medium-sized self-adhesive notes and two stacks of small self-adhesive notes.

17. A self-adhesive note assembly comprising a support having on one side a first surface and second surface, wherein the first surface has thereon at least one stack of self-adhesive notes and the second surface has thereon at least one stack of self-adhesive notes, wherein the support can be folded such that the first surface faces the second surface.

18. A self-adhesive note assembly as in item 17 above, wherein the first surface has thereon one stack of large self-adhesive notes and the second surface has thereon one stack of medium-sized self-adhesive notes and two stacks of small self-adhesive notes.

19. A self-adhesive note assembly as in item 17 above, wherein the first surface and the second surface are connected via a crease in the support.

20. A self-adhesive note assembly as in item 18 above, wherein the first surface and the second surface are connected via a crease in the support.

21. A self-adhesive note assembly as in item 17 above, wherein the support further comprises a middle portion between the first surface and the second surface, wherein the first surface and the middle portion are connected via a first crease in the support, and the middle portion and the second surface are connected via a second crease in the support, wherein the middle portion has a width such that at least one stack of self-adhesive notes on the first surface can be flush with at least one stack of self-adhesive notes on the second surface when the assembly is folded.

22. A self-adhesive note assembly as in item 18 above, wherein the support further comprises a middle portion between the first surface and the second surface, wherein the first surface and the middle portion are connected via a first crease in the support, and the middle portion and the second surface are connected via a second crease in the support, wherein the middle portion has a width such that the stack of large self-adhesive notes on the first surface can be flush with at least one stack of self-adhesive notes on the second surface when the assembly is folded.

23. A self-adhesive note assembly as in item 17 above, wherein the support further comprises a gap portion, wherein the first surface and the gap portion are connected without any crease in the support, and the gap portion and the second surface are connected without any crease in the support, wherein the gap portion has a width such that at least one stack of self-adhesive notes on the first surface can be flush with at least one stack of self-adhesive notes on the second surface when the assembly is folded.

24. A self-adhesive note assembly as in item 18 above, wherein the support further comprises a gap portion, wherein the first surface and the gap portion are connected without any crease in the support, and the gap portion and the second surface are connected without any crease in the support, wherein the gap portion has a width such that the stack of large self-adhesive notes on the first surface can be flush at least one stack of self-adhesive notes on the second surface when the assembly is folded.

25. A self-adhesive note assembly as in item 17 above, wherein the support has indentations, perforations or one or more score lines therein.

### BRIEF DESCRIPTION OF THE DRAWINGS

FIG. 1 shows an embodiment of the present invention in which the support is a cube.

FIG. 2 shows an embodiment of the present invention in which the support is an elongated cube.

FIG. 3 shows an embodiment of the present invention in which the support is a flat support.

FIG. 4 shows an embodiment of the present invention in which the support has on one side a first surface, a middle portion, and a second surface, wherein the first surface and the middle portion are connected via a first crease in the support, and the middle portion and the second surface are connected via a second crease in the support.

FIG. 5 shows an embodiment of the present invention in which the support has on one side a first surface, a gap portion, and a second surface, wherein the first surface and the gap portion are connected without any crease in the support, and the middle portion and the second surface are connected without any crease in the support.

### DETAILED DESCRIPTION OF THE INVENTION

The support can be made of any suitable material, such as paper, cardboard or plastic. The support material can be coated with a coating material to provide suitable adherence and release characteristics so that the stack of notes can adhere to the support and so that the bottom note in the stack can be taken off of the support when desired. Such materials are well known in the art, as evidenced by the coated support used in Post-it® Notes brand of self-adhesive notes manufactured by 3M.

When the support is in the form of a three dimensional object (e.g., a cube (i.e., a three dimensional object having six square faces), an elongated cube (i.e., a three dimensional object having either all rectangular faces or a combination of square and rectangular faces) or an object having triangular upper and lower faces and three rectangular or square faces), it is preferably made of plastic or cardboard.

When the support is a flat support, it can be a paper support in order to enable existing support materials for self-adhesive note assemblies to be used. If a more rigid support is desired for the flat support, a cardboard or plastic support can preferably be used.

For the support having on one side a first surface and second surface, wherein the support can be folded such that the first surface faces the second surface, the support is preferably made from cardboard or plastic in the design where at least one crease is present in the support, and it is preferably made from paper or plastic in the design without any crease in the support. The folding support design is particularly useful for traveling, because it can be placed in a briefcase in folded form such that the self-adhesive notes are not exposed and thus do not peel off and create clutter in the briefcase.

When the support is a flat support or a support having on one side a first surface and a second surface, the support can have perforations, indentations or one or more score lines to facilitate separation of the support to form a smaller support for one or more remaining stacks of self-adhesive notes after at least one stack of self-adhesive notes has been completely used, or to provide individual stacks of self-adhesive notes as desired.

The stack of self-adhesive notes can be made from paper or plastic sheets, wherein each sheet has a band of adhesive running across a portion of its back surface, such as across the upper portion of the back surface. Such a stack of self-adhesive notes is well known in the art, as evidenced by the stack of self-adhesive notes used in Post-it® Notes brand of self-adhesive notes manufactured by 3M. The adhesive can be a repositionable adhesive well known in the art, such as the pressure sensitive adhesives described in U.S. Pat. Nos. 3,691,140 and 4,166,152, the disclosures of which are incorporated herein by reference. In the embodiments of the present invention where plural stacks of self-adhesive notes are present on a surface of the support, the adhesive part of each stack is preferably positioned toward the interior of the arrangement of the stacks as much as possible so that an individual self-adhesive note on top of a stack can be easily accessed from the periphery of the arrangement.

The stacks of self-adhesive notes used in the present invention can be various colors. In one design, purple, blue, green, yellow, orange, and red notes can be used. In another design, lavender, light blue, light green, light yellow, light orange, and pink notes can be used. In other designs, other assortments of colors can be used. In still other designs, a single color can be used, such as a traditional light yellow color often used for self-adhesive notes in the art.

The stacks of self-adhesive notes used in the present invention can be various sizes. Large self-adhesive notes can be 3 inches×5 inches (76 mm×127 mm) or approximately that size as is often used in the art. Medium-sized self-adhesive notes can be 3 inches×3 inches (76 mm×76 mm) or approximately that size as is often used in the art (e.g., one version of Post-its Notes brand of self-adhesive notes manufactured by 3M in this range measures 2⅞ inches×2⅞ inches (73 mm×73 mm). Small self-adhesive notes can be 1.5 inches×2 inches (38 mm×50 mm) or approximately that size as is often used in the art. Page markers, which are approximately 0.5 inch×1.75 inches (12.7 mm×44.4 mm), and flags, which are approximately 0.47 inch×1.7 inches (11.9 mm×43.2 mm), can also be used in the present invention.

The stacks of self-adhesive notes contain a suitable number of sheets, such as 100 or 50. For example, in a foldable embodiment of the present invention, the stacks could contain 50 sheets each to reduce the thickness of the embodiment when it is in its folded form.

Non-limiting examples of self-adhesive notes which can be used in the present invention can be found in U.S. Pat. Nos. 4,907,825 and 5,411,168, the disclosures of which are incorporated herein by reference.

The self-adhesive note assemblies can be made by providing the desired support and then adhering on the desired surfaces thereof the desired stacks of self-adhesive notes. The self-adhesive note assemblies of the present invention can be used by accessing the desired self-adhesive note and then removing it from the top of a stack having that note. For example, in the foldable design, if the assembly is folded, the user would unfold it to reveal the assortment of notes, and then the user would remove the desired self-adhesive note from the top of a stack having that note.

The present invention is also described by reference to the attached figures, as indicated below.

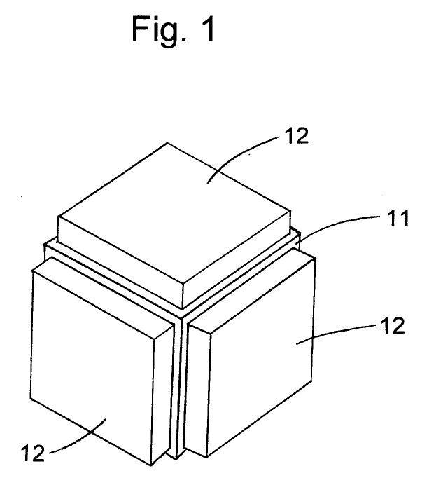

FIG. 1 shows an embodiment of the present invention in which the support is a cube. In particular, cube support 11 has thereon stacks of self-adhesive notes 12.

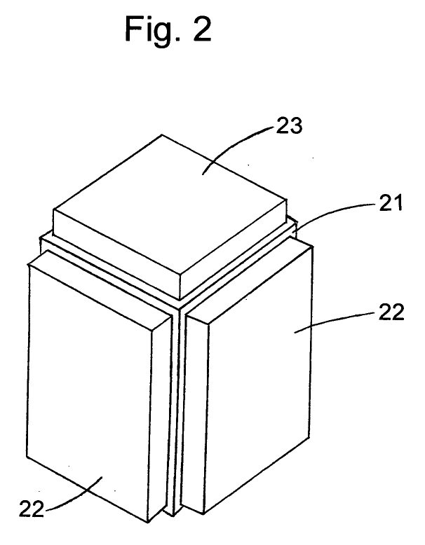

FIG. 2 shows an embodiment of the present invention in which the support is an elongated cube. In particular, elongated cube support 21 has thereon stacks of rectangular self-adhesive notes 22 and square self-adhesive notes 23.

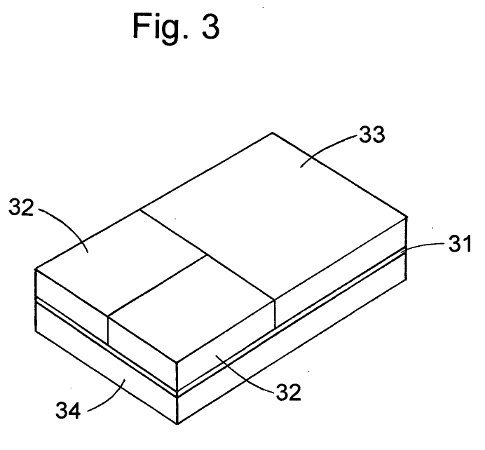

FIG. 3 shows an embodiment of the present invention in which the support is a flat support. In particular, flat support 31 has thereon stacks of small self-adhesive notes 32, medium-sized self-adhesive notes 33, and large self-adhesive notes 34.

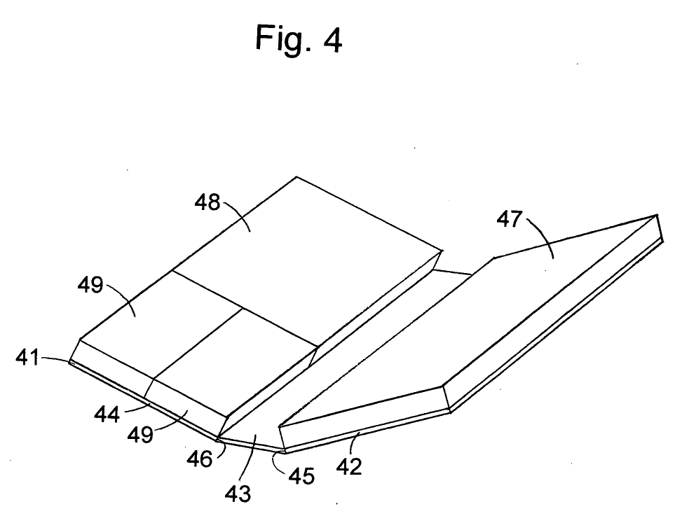

FIG. 4 shows an embodiment of the present invention in which the support 41 has on one side a first surface 42, a middle portion 43, and a second surface 44, wherein the first surface 42 and the middle portion 43 are connected via a first crease 45 (which could be, e.g., a score line) in the support 41, and the middle portion 43 and the second surface 44 are connected via a second crease 46 (which could be, e.g., a score line) in the support 41. The first surface 42 has thereon a stack of large self-adhesive notes 47, and the second surface 44 has thereon stacks of medium-sized self-adhesive notes 48 and small self-adhesive notes 49. It should be noted that there could be indentations, perforations or score lines (not shown) between the stack of medium-sized self-adhesive notes 48 and the stacks of small self-adhesive notes 49, and there could be indentations, perforations or score lines (not shown) between the stacks of small self-adhesive notes 49 themselves.

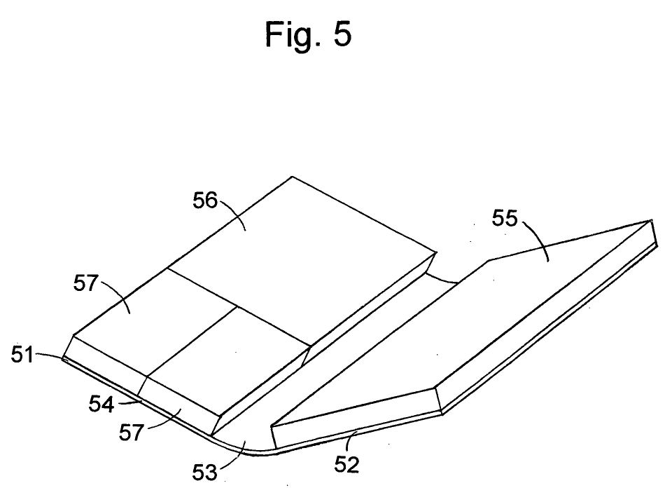

FIG. 5 shows an embodiment of the present invention in which the support 51 has on one side a first surface 52 having thereon a stack of large self-adhesive notes 55, a gap portion 53, and a second surface 54 having thereon stacks of medium-sized self-adhesive notes 56 and small self-adhesive notes 57, wherein the first surface 52 and the gap portion 53 are connected without any crease in the support 51 (although there could be, e.g., indentations or perforations in the support 51 to facilitate separation of the first surface 52 and the gap portion 53), and the gap portion 53 and the second surface 54 are connected without any crease in the support 51 (although there could be, e.g., indentations or perforations in the support 51 to facilitate separation between the gap portion 53 and the second surface 54). It should be noted that there could be indentations, perforations or score lines (not shown) between the stack of medium-sized self-adhesive notes 56 and the stacks of small self-adhesive notes 57, and there could be indentations, perforations or score lines (not shown) between the stacks of small self-adhesive notes 57 themselves.

While the present invention has been described in detail and with reference to specific embodiments thereof, it will be apparent to one of ordinary skill in the art that various changes and modifications can be made therein without departing from the spirit and scope thereof.

What is claimed is:

1. A self-adhesive note assembly comprising a support in the form of a three dimensional object and at least one stack of self-adhesive notes on each of plural surfaces of the three dimensional object.

2. A self-adhesive note assembly as in claim 1, comprising a support in the form of a cube and at least one stack of self-adhesive notes on each of plural surfaces of the cube.

3. A self-adhesive note assembly as in claim 2, wherein at least one stack of self-adhesive notes is present on each surface of the cube.

4. A self-adhesive note assembly as in claim 3, comprising a support in the form of a cube and only one stack of self-adhesive notes on each surface of the cube.

5. A self-adhesive note assembly as in claim 4, wherein each stack of self-adhesive notes is a different color from each other stack of self-adhesive notes.

6. A self-adhesive note assembly as in claim 5, comprising a purple stack of self-adhesive notes on a first surface of the cube, a blue stack of self-adhesive notes on a second surface of the cube, a green stack of self-adhesive notes on a third surface of the cube, a yellow stack of self-adhesive notes on a fourth surface of the cube, an orange stack of self-adhesive notes on a fifth surface of the cube, and a red stack of self-adhesive notes on a sixth surface of the cube.

7. A self-adhesive note assembly as in claim 5, comprising a lavender stack of self-adhesive notes on a first surface of the cube, a light blue stack of self-adhesive notes on a second surface of the cube, a light green stack of self-adhesive notes on a third surface of the cube, a light yellow stack of self-adhesive notes on a fourth surface of the cube, an light orange stack of self-adhesive notes on a fifth surface of the cube, and a pink stack of self-adhesive notes on a sixth surface of the cube.

8. A self-adhesive note assembly as in claim 2, comprising at least two stacks of self-adhesive notes on at least one surface of the cube.

9. A self-adhesive note assembly as in claim 8, wherein one stack of self-adhesive notes on the cube is a different color from another stack of self-adhesive notes on the cube.

10. A self-adhesive note assembly as in claim 8, wherein one stack of self-adhesive notes on the cube is a different size from another stack of self-adhesive notes on the cube.

11. A self-adhesive note assembly as in claim 1, comprising a support in the form of an elongated cube and at least one stack of self-adhesive notes on each of plural surfaces of the elongated cube.

12. A self-adhesive note assembly as in claim 11, wherein at least one stack of self-adhesive notes is present on each surface of the elongated cube.

13. A self-adhesive note assembly as in claim 11, wherein the elongated cube has four rectangular faces and two square faces.

14. A self-adhesive note assembly as in claim 11, wherein the elongated cube has six rectangular faces.

15. A self-adhesive note assembly comprising a flat support having a top surface and a bottom surface, wherein the top surface has thereon at least one stack of self-adhesive notes and the bottom surface has thereon at least two stacks of self-adhesive notes.

16. A self-adhesive note assembly as in claim 15, wherein the top surface has thereon one stack of large self-adhesive notes and the bottom surface has thereon one stack of medium-sized self-adhesive notes and two stacks of small self-adhesive notes.

17. A self-adhesive note assembly comprising a support having on one side a first surface and second surface, wherein the first surface has thereon at least one stack of self-adhesive notes and the second surface has thereon at least one stack of self-adhesive notes, wherein the support can be folded such that the first surface faces the second surface.

18. A self-adhesive note assembly as in claim 17, wherein the first surface has thereon one stack of large self-adhesive notes and the second surface has thereon one stack of medium-sized self-adhesive notes and two stacks of small self-adhesive notes.

19. A self-adhesive note assembly as in claim 17, wherein the first surface and the second surface are connected via a crease in the support.

20. A self-adhesive note assembly as in claim 18, wherein the first surface and the second surface are connected via a crease in the support.

21. A self-adhesive note assembly as in claim 17, wherein the support further comprises a middle portion between the first surface and the second surface, wherein the first surface and the middle portion are connected via a first crease in the support, and the middle portion and the second surface are connected via a second crease in the support, wherein the middle portion has a width such that at least one stack of self-adhesive notes on the first surface can be flush with at least one stack of self-adhesive notes on the second surface when the assembly is folded.

22. A self-adhesive note assembly as in claim 18, wherein the support further comprises a middle portion between the first surface and the second surface, wherein the first surface and the middle portion are connected via a first crease in the support, and the middle portion and the second surface are connected via a second crease in the support, wherein the middle portion has a width such that the stack of large self-adhesive notes on the first surface can be flush with at least one stack of self-adhesive notes on the second surface when the assembly is folded.

23. A self-adhesive note assembly as in claim 17, wherein the support further comprises a gap portion, wherein the first surface and the gap portion are connected without any crease in the support, and the gap portion and the second surface are connected without any crease in the support, wherein the gap portion has a width such that at least one stack of self-adhesive notes on the first surface can be flush with at least one stack of self-adhesive notes on the second surface when the assembly is folded.

24. A self-adhesive note assembly as in claim 18, wherein the support further comprises a gap portion, wherein the first surface and the gap portion are connected without any crease in the support, and the gap portion and the second surface are connected without any crease in the support, wherein the gap portion has a width such that the stack of large self-adhesive notes on the first surface can be flush at least one stack of self-adhesive notes on the second surface when the assembly is folded.

25. A self-adhesive note assembly as in claim 17, wherein the support has indentations, perforations or one or more score lines therein.
